(19) United States
(12) Patent Application Publication
(10) Pub. No.: US 2017/0138747 A1
(43) Pub. Date: May 18, 2017

(54) Navigation System

(71) Applicant: Information Edge Limited, Surrey (GB)

(72) Inventors: Vilosh Brito, Surrey (GB); Kent Yap, Auckland (NZ); Greg Thorburn, Auckland (NZ)

(73) Assignee: Information Edge Limited, Surrey (GB)

(21) Appl. No.: 15/290,854

(22) Filed: Oct. 11, 2016

(30) Foreign Application Priority Data
Oct. 12, 2015 (GB) 1517986.4

(51) Int. Cl. G01C 21/34; G01C 21/36

(52) U.S. Cl. CPC G01C 21/3415; G01C 21/3667

(57) ABSTRACT

Some embodiments relate to methods and systems for supporting location detection and navigation technologies. Destination information defining a desired destination can be obtained. A primary database can be queried to identify a historical visit to the destination. The primary database can include historical data for a plurality of historical journeys. The historical visit can include measured location information for the destination.

### CROSS-REFERENCE TO RELATED APPLICATIONS

This application claims the benefit of and priority to Great Britain Application Serial Number GB1517986.4, filed on Oct. 12, 2015, which is hereby incorporated by reference in its entirety for all purposes.

### FIELD

The present invention relates to a navigation system, in particular a navigation system and device for optimising journey times.

### BACKGROUND

To reach an unknown destination, people need to be provided with directions to reach the destination. Traditionally, this has been done by following a map, where the user determines their route to the destination by interpreting the roads and pathways on the map. The user would typically identify the route they intended to take on the map, and then travel along that route to their destination.

More recently users have used electronic maps. These digital maps are typically displayed on a screen, for example on a computer screen, a mobile device, a tablet computer, or a dedicated digital map display device.

In tandem with the digital display of maps, devices that utilise a global navigation satellite system have been developed, for example the Global Positioning System (GPS). GPS devices use signals from earth-orbiting satellites to determine the position of the device on the surface of the earth. Modern devices for helping a user to navigate to a destination often can also display a digital map. When the device also has the ability to display a map, the device can overlay the position of the device on the digital display of the map. These devices can typically update in essentially real time, allowing movement of the GPS device to be shown as movement on the digital display of the map.

GPS navigation devices have also been developed. These navigation devices allow a user to input a destination to the navigation device. The navigation device contains a digital representation of the routes (for example, roads and paths) on the map, and as such can determine a journey from a source location to a destination. The source location may be where the device is currently located. The destination may be a street address and/or postcode to which the user wishes to travel.

Once a journey has been determined, the user can set off on that journey with the navigation device. Because the navigation device can update its current position in essentially real time, the device itself can monitor the user's progress along the journey. This progress can be displayed to the user.

A journey will typically involve taking a specified route along a number of paths and/or roads. As a consequence, if the user is to follow the route specified by the device, then the user will have to make certain turns. For example, they may have to turn onto a specific road at a junction, or take a specific exit at a roundabout. A journey will typically be made up of a number of these decisions. The navigation device can tell the user how to correctly progress along their journey and to successfully reach their destination. Because the device can updated its position in essentially real time, the device can determine when the user is approaching a decision point (e.g. roundabout, junction, traffic lights), and instruct the user how they should proceed. The instructions may for example be spoken instructions, or they may be visual instructions provided on a screen of the navigation device, or they may be a combination of the two. The user may decide to follow the instructions, or ignore the instructions and go along a different route to that originally planned by the navigation device.

Particularly when used to direct a driver in a vehicle along a journey, difficulties are presented when there is heavy traffic along that journey. This causes delays to the user. These delays are annoying for the user, but may also be cause other problems. For example, if the user has to be at their destination before a certain time, or if the user has to complete a certain number of journeys within a given timeframe. Both of these targets can prove difficult to achieve when a journey that has been planned by the navigation device passes through areas of heavy traffic or other reasons for delay along a road. Furthermore, cars that spend more time driving (for example because they spend time moving slowly or stopped in traffic) will be use more fuel, and consequently be more damaging to the environment. A user that can avoid traffic and drive their vehicle more quickly to their destination will therefore cause less damage to the environment.

Route optimisation methods used by existing computer programs tend to optimise the routes by planning a route that minimises the distance travelled. However, there may have been a different route that was longer in distance, but may in fact have resulted in a lower total journey time.

Traffic flow and incidences of heavy traffic of course vary with time: at sometimes traffic will be flowing freely along a given road, yet at other times the traffic may be heavy along the same road. Traffic may sometimes slow or come to a standstill. Junctions/roundabouts may also present areas of heavy traffic at some times, but not at other times. Navigation devices do not have any way of accounting for this temporal variation in traffic patterns, and as such, will sometimes direct a user along a road where traffic is heavy, delaying the user's progress to their destination.

Different navigation devices have varying degrees of accuracy. This accuracy may be how accurately the device can determine its current position. If a device cannot determine its position accurately, then it can present difficulties in determining when a location has in fact been reached. For example, if the device is inaccurate, it may not be able to direct a user exactly to their desired destination. Instead the device may indicate that they are at their destination, when in fact they are some distance away.

This accuracy problem is exacerbated by the use digital maps that do not know exactly where an address is located. As a first example, route finding algorithms may not know the exact location of a house number on a street, and most likely will extrapolate along the length of the road to make a guess at the correct location. While this method may sometimes direct the user to close to the correct location, many times it will not. A second example is a home address where the house has a name rather than a number: in this case the navigation device will not know the exact location and will probably only be able to direct the user to the correct street. This again constitutes a problem for navigation device users, who have to spend significant time locating the correct destination after the navigation device has taken them effectively as close as it can.

In various tests that have been carried out, different devices have been ranked by how accurate or otherwise the testers found them to be. Even a top-ranked product would not be accurate in all situations and in different locations for example in rural locations and/or in urban locations.

Of course a navigation device can only present instructions to the user that they should follow to reach their destination. The user is not obliged to follow these directions. A user who doesn't follow the directions presented to them by their navigation device may as a result take a non-optimal route. Such a non-optimal route may take the user longer to complete than the route down which the navigation device intended to direct them.

In particular, the delivery of hot food from a production point to various destinations within a demarcated territory present issues for satellite navigation devices. It differs from route scheduling systems which look to optimise a journey from a delivery point such as a warehouse, to multiple locations with the motor vehicle doing the deliveries then returning to the delivery point. Hot food delivery is different in that deliveries have to be made in a short period of time—usually within 15 to 20 minutes. Multi drops are discouraged and only employed when the delivery resources i.e. the number of drivers are insufficient to the demand. In the hot food delivery scenario, it is of paramount importance that the deliveries are made as quickly as possible.

The present invention seeks to avoid the disadvantages associated with the prior art.

### SUMMARY OF THE INVENTION

The present invention aims to solve the above problems by providing, according to a first aspect, a method of journey optimisation is provided. The method including the steps of obtaining start and end locations for a first journey; determining a first route between the start and end locations; segmenting the first route into a plurality of first journey segments; comparing a first journey segment to historical data stored on a database; determining a second route between the start and end locations based on the comparison of a first journey segment to the historical data. The second route is predicted to take a shorter time than the first route.

The above described invention allows for route optimisation that can make use of information about historical journeys. In particular, dynamic traffic patterns found in the historical data can be used. This allows a user of the method to make use of the kind of information that an experienced road user (who knows the region in which the journey is taking place) would know from experience. For example, an experienced person would know that there is always heavy traffic in a certain area at a certain time of day. A driver who is inexperienced in driving around that area may not know this information, and in the absence of the present invention, may be delayed by the heavy traffic. The present invention allows the inexperienced driver to make use of historical data, in order to avoid a region of heavy traffic and complete their journey more quickly.

The start and end locations may be provided by a user. The start location of may be a user's current location. Alternatively, the start and end locations may be obtained from a prepopulated list of start and end locations.

The start and/or end locations may be provided as a street address. The start and/or end locations may be provided as a postcode and a building name/number, for example.

The first route between the start and end locations may be determined by conventional route finding algorithms. The first route may, for example, be based on minimising a predicted travel time to complete the first journey based on the distance to the destination.

A sequence of journeys to be undertaken may be provided as a list of corresponding start and end points. This list of journeys may, for example, correspond to a number of deliveries to be undertaken. The deliveries may be undertaken by a delivery driver. The deliveries may be delivered food, where quick delivery is particularly important.

The start location may be the current location of the device that implements the method. The start location of a journey may the end location of another journey. Specifically, the start location of a journey may be the end location of the preceding journey. Where a series of journeys are planned, the journey optimisation may take place globally for the combination of all of the journeys in the series.

In the comparing step, a segment identified in the first journey is compared to historical journey data. The comparison may include calculating the difference in predicted time taken to complete the first segment and predicted time taken for alternative routes in the historical data. The comparison may also be based on velocity in the segment, for example. Segments of the first journey may be identified as choke points on the basis of the historical data to the same or similar destination. A choke point may be a portion of the first journey that has historically been a slow portion of the journey, for example due to heavy traffic.

The slowest segments of the first journey may be identified as choke points.

A second route route may be determined on the basis of the identified choke points. The second route may be determined to avoid the identified choke points. When suggesting alternate routes to avoid choke points, the following steps may be taken:
First, identify the closest intersection before and after the choke point;
second, using these intersections (for example, a road junction) as the start and end point, identify a route that avoids the choke point;
using the distance of the alternate route and the average speed travelled on previous journeys (excluding any choke points), estimate the time required to travel the alternate route, and;
if the estimated time required on the alternate route is less than the time taken in the choke point, a new alternate route would that avoids the choke point would be provided.

The route that avoids the choke point may be determined by an existing route finding system.

The present invention has many benefits, for example, reduced journey times which means lower fuel consumption, and less pollution.

Further optional features of the first aspect of the invention are set out below.

Preferably, the comparison step is carried out for more than one of the first journey segments.

Advantageously, the comparison step is carried out for all of the first journey segments.

The above method allow for a greater proportion of a journey to be optimised.

Alternatively, the whole of the first journey may be optimised. Each segment may be optimised separately.

Conveniently, further including the step of determining a predicted time for the second route.

The predicted time for the second route may be compared to the predicted time for the first route. This comparison can be used to determine if the second route would be preferable to the first route. In other words, would it be faster for a user to take the second route instead of the first, based on the predicted times for the first and second routes? The second route may be presented to a user, who can then choose to take the second route, which may be faster. This is because the second route has been optimised based on knowledge of historical journeys, which, for example, may include details of historical traffic patterns.

Preferably, the second route excludes at least one segment of the first route.

The second route is different from the first route because in the comparison step, it was determined that a second route would be preferable to the first route. The excluded segment may be a choke point. The preferred second route is not the same as first route as it does not include at least one of the segments of the first route. Equally, the second route may not include any of the segments of the first route.

Advantageously, the method further includes a step of replacing the first route with second route if the predicted time for the second route is shorter than the predicted time of the first route.

The replacement of the first route with second route may mean that the user can then be presented with the second route. The user may then be directed to follow the second, optimised, route. By doing this, the user takes a route that is preferred over the first route. By taking into account the historical data in the determination of the second route, a user is able to reach their desired destination (the end location) in the shortest possible time.

Conveniently, the second route is segmented into a plurality of second route segments.

Preferably, at least one of the second route segments is compared to the database.

Advantageously, the predicted time for the second route uses data from the database.

By comparing the second route to the database, it is possible to optimise the second route based on the historical data. If the second route includes a segment that is shown by the historical data to be non-optimal, then the optimisation of the second route can allow this segment to be identified and avoided.

Conveniently, the method further includes a step of predicting metrics for the first journey segments.

The metrics may include any of: the time taken to travel through a segment; the velocity through a segment, and; the average velocity in a segment, the time spent in a segment. The metrics may also include any combination of these.

Preferably, the historical data includes a plurality of historical journeys, wherein each historical journey is between a historical start location and the historical end location.

Advantageously each of the historical journeys includes at least one historical segment.

The historical journeys may be stored in the database as segments.

Conveniently, each of the historical segments includes historical metrics.

The metrics may include any of: the time taken to travel through a historical segment; the velocity through a historical segment, and; the average velocity, the time spent in a historical segment. The historical metrics may also include any combination of these.

Preferably, the method further comprises identifying relevant historical segments that correspond to segments of the first journey.

The historical metrics that are identified as those historical segments that share a common route with the first journey (a portion of the first route corresponds to a portion of the route in a historical segment).

Advantageously, the method further comprises identifying relevant historical segments that correspond to segments of the first journey.

Conveniently, the method further comprises comparing predicted metrics for the first journey segments to historical metrics of the relevant historical segments.

By comparing the metrics predicted for the first journey, and comparing to metrics corresponding to historical journeys, the method is able to determine whether a segment of a historical route would be a preferable route to take when compared to the segment of the first route. For example, if the predicted time spent in a segment of the first route is longer than the time spent in the historical segment, then it may be preferable to use that segment of the historical journey as part of the second route. The metrics in the historical data may be determined from actual measurements taken during the historical journeys.

Conveniently, the method further comprises identifying a first journey segment as a choke segment from the historical data.

Preferably, the at least one choke segment is identified by historical metrics.

Advantageously, the historical metrics and predicted metrics include at least one of average speed, minimum speed, maximum speed, time taken in sector, and distance travelled in a segment.

Conveniently, the second route avoids at least one of the at least one identified choke segments.

For each historical journey, the historical data may include GPS data for the journey. The GPS data may include latitude, longitude, velocity, time, heading etc. The GPS data may include a sequence of values measured at points along the journey. The measurements may have been made periodically. For example, the GPS data may include a sequence of velocity values corresponding to a measurements along a historical journey. In the velocity example, the velocity can be determined along the journey as a function of time or distance.

A segment may be identified a choke segments, where the historical data suggests that the predicted time spent in the segment will be long when compared to a predicted time from a conventional route finding process. For example, if the traffic is historically heavy in that segment, then by analysing the historical data (for example, time spent in corresponding historical segments), then such a segment of the first route may be identified as a choke point.

Because the second route avoids any of these identified choke points, the second route may result in the destination being reached more quickly than if the first route is used.

Preferably, the segmenting step further comprises analysing the speed of a vehicle travelling along a similar historical journey.

Advantageously, changes in the speed of the vehicle are identified.

Conveniently, the boundaries of the segments are associated with significant changes in speed.

The segmenting step may include breaking down the journey into segments at street level. The segmenting step may include using historical journey data for at least one historical journey that shares a common portion with the first route. The segmenting step may use GPS data for a historical journey to determine the segments. Determining the segments may include determining the boundaries between segments. For example, the segmenting step may identify sharp changes in velocity in a historical journey. The GPS data for the historical journeys may can be used to identify the position of the vehicle at the times of the identified sharp changes in velocity. Such sharp changes in velocity may indicate that the vehicle was accelerating or decelerating, rather than travelling at a constant speed. The segmenting step may identify the geographical location of segment boundaries by calculating the location of the change in velocity along a historical journey.

In this way, the boundaries of the segments are defined dynamically according to the speed of the vehicle, which may be a proxy for the heaviness of the traffic. It may also be a method of identifying the presence of road features that cause vehicle speeds to change, for example, traffic lights.

Preferably, at least one of the segments corresponds to at least one of a section of a road, a road junction, a roundabout, or a set of traffic lights.

Advantageously, the historical data includes segment data, the segment data including at least one of: geographical boundaries for the segment, average speed, minimum speed, maximum speed, distance travelled in segment, and time taken in a segment of a historical journey.

Conveniently, the historical data includes the start and end times of a historical journey.

Preferably, a first journey segment is compared to historical data for journeys that occurred during a defined time of day.

Advantageously, the defined time of day is the times of day of the first journey.

By including the start and end times of the historical journeys, the optimisation may be based on using data from historical journeys that occurred at a similar time of day as the first journey. In this way, the method is able to take account of traffic patterns that change based on the time of day. For example, traffic may be heavier during a “rush hour”. If a user's intention is to make their desired journey during such a rush hour, then the present invention may allow the user to make use of historical data for historical journeys made during a rush hour. In this was the historical data will include traffic patterns that took place during rush hours. Conversely, it may be undesirable for the optimisation step to use historical journey data from historical journeys that took place at a different time of day from the time of the desired journey. During other times of the day, the traffic patterns may be different. The present invention allows the optimisation step to avoid historical data for journeys that took place at a different time of day.

Preferably, the historical data includes the vehicle type that undertook each historical journey.

Advantageously, the first route is only compared to historical data for which the vehicle is of a similar type to the user's vehicle.

Conveniently, the vehicle type is at least one of a moped, a lorry, a car, a motorbike, or a bicycle.

By taking account of the vehicle type, the present invention can optimise the by using data which corresponds to historical journeys undertaken in vehicles that are the same or similar to the vehicle that will be undertaking the desired journey. Different types of vehicle may be affected by traffic in different ways, and the present invention can take account of this. For example, a moped or motorbike may be significantly less delayed by a traffic jam than a car would be.

The present invention may take into account the type of vehicle use to make the journey, such as a moped or a standard car. The optimised routes for the different vehicles will differ as certain traffic conditions will only affect larger vehicles and not mopeds, for example.

Preferably, wherein the first and second routes are different.

Advantageously, the obtaining step further comprises obtaining at least one stop along the first route.

Conveniently, the first route and the second route are determined to pass through the at least one stop.

Preferably, the at least one stop is a plurality of stops.

Advantageously, a final stop is not the end location.

The first route may include a number of stops, through which the first route may pass. These may be locations that a user has to visit, for example to make deliveries. The second route may then be optimised with a limitation that the second route should still pass through the same stops as the first route. The final stop on a route need not be the end location of the journey. For example, the end location may be a delivery depot, while the final stop on the journey may be a final delivery location.

The second route does not necessarily have to pass through the stops in the same order as in the first route. The ordering of the stops in the second journey may be altered from the order of the stops in the first journey. This may allow for a shorter second route than the first route. For example, a stop located in a region of heavy traffic at a given time of day can visited at a different time of day by changing its order in the second journey, thereby avoiding the heavy traffic period in that region.

Conveniently, the plurality of historical journeys includes a close journey, wherein the historical end location of the close journey is within a predefined distance of the end location.

Preferably, at least one of the segments of the second route are equal to at least one of the segments of the close journey.

A close journey may be a historical journey (details of which are stored in the database) for which the end location is similar to the desired end location of the first journey. How similar the end locations of the close journey and the first journey should be may be a predefined parameter. It may be that end locations within a predefined distance may be defined as a similar in this sense. It may be that end locations on the same street are defined as similar. Or it may be that addresses on the same street and separated by a predefined number of houses are defined as similar. For example, if the end location of the first journey is 17 Acacia Street, then the end location for a close journey may be 5 Acacia Street. The skilled person will understand that this is merely provided by way of example, and there are a number of ways of defining the closeness of two addresses that fall within the scope of the present invention.

Historical data may also include data from return journeys from the destination back to a start point. The data to populate the database does not necessarily only correspond to journeys that were instructed by a user, the data could include times when a user of the device was travelling for any other reason. In this way the amount of potential historical data that may be included in future optimisations can be increased.

Advantageously, the method further includes the step of acquiring details of a second journey.

A second journey may be optimised as well as the first journey. The second journey may follow-on directly from the first journey. A user may have any number of separate journeys that they may wish to make. Each of these journeys may be optimised according to the present invention.

Conveniently, a final segment comprises a concluding portion of the first route, the concluding portion having a predicted final distance to the destination.

Preferably, an actual final distance travelled in the final segment is recorded.

Advantageously, the difference between the actual final distance and the predicted final distance is calculated.

Conveniently, the actual location of the destination is recorded as a place point if the difference is greater than a configured distance.

Preferably, the place point includes a measurement of the device at the destination.

A user may in fact travel to the final destination. However, if the destination is not exactly where it was predicted to be by the first or second routes, then the user will have to find the destination themselves. For example, the user may have to travel along a street to identify the correct house number. This may be a time consuming process.

In the present invention, if a difference between the predicted distance in the final segment and the actual distance travelled in the final sector are different, than that may be an indication that the destination was not exactly where it was predicted to be. With the present invention, when the actual destination is in fact reached a place point is made. A place point includes measurement of the location of the destination. The place point can then be sent to a database for storage. Another user who would like to the travel to the same destination can access the database and use the measured location information included with the place point.

In this way, a future journey to the same destination, instead of using the predicted location, which is incorrect, the location of the place point can instead be used as the destination.

In this way, a future journey can progress directly to the correct location for the desired destination, without the time-consuming step of searching for the exact location.

Advantageously, the configured distance is a final fraction of the predicted final distance.

Conveniently, wherein the final fraction is 10%, for example.

When a route to an end location is actually undertaken by a user, the user will be directed to what is thought to be the correct location. In a final segment the distance to what is thought to be the end location may be predicted. The actual distance travelled by a user to get to the true location may then be recorded when the journey is undertaken. If the user travelled a significantly shorter or longer distance than the predicted distance to the location, then this may be an indication that in fact the predicted location of the address was incorrect. In the event that this occurs, the present invention may include the measurement of an actual position of the end location (when it is reached). For future journeys to the same end location, the historical data can be utilised to send the user to the exact location of the address, rather than the predicted location.

For example, conventional route finding algorithms often do not know the exact location of houses. Either the location is predicted based upon house number, which is used to predict a distance along a road where the house is expected to be located. Or alternatively, the exact location may simply be unknown (for example if the house has a name instead of a number). In these cases a database of exact (measured) locations for addresses visited on historical journeys can be created, and used for future journeys on a different device. A user of the method of the present invention can therefore progress more directly to their desired destination.

Preferably, the database is a relational database.

Storing the historical data in a relational database may allow queries to be produced to extract journey information for a given time of day or sector efficiently.

Advantageously, the method further comprises the step of recording a deviation from a route made by the user.

Conveniently, the method further includes the step of determining if the deviation resulted in a shorter or longer total journey time.

By recording the actual journey taken by a user, the present invention can make use of driver knowledge, for example knowledge of local traffic patterns. If a user deviates from a route, then any advantage or disadvantage (e.g. a shortened or lengthened journey) from the deviation can be determined. If it is found that a deviation from a planned route resulted in a shorter journey than was otherwise predicted, then the deviation may be used for future journeys. In this way, the historical database can be populated with historical journeys that include the local knowledge of experienced users. By using the method of the present invention, an inexperienced user can make use of this knowledge, allowing more efficient journeys.

Preferably, the method further includes recording actual journey data taken during at least one journey on a second database.

Advantageously, the method further includes uploading the actual journey data from the at least one journey to the database.

According to a second aspect of the present invention, a device configured to optimise a journey is provided. The device includes: means for obtaining start and end locations for a first journey; a first route processor configured to determine a first route between the start and end locations; a segmentation processor configured to segment the first route into a plurality of first journey segments; a comparison processor configured to compare a first journey segment to historical data stored on a primary database, and; a second route processor configured to determine a second route between the start and end locations based on the comparison of a first journey segment to the historical data, wherein the second route is predicted to take a shorter time than the first route.

It will of course be appreciated, that while the device is described with a number of processors, these processors may be made up of any number of physical processors. For example, the device may include a single processor that is configured to perform all of functions of the device.

The means for obtaining the start and end locations of the journey may include a keyboard. The keyboard may be a touchscreen keyboard on a screen of the device. Equally, the start and end locations may be obtained from a digital source, for example from a database. The start and end locations may be may be sent to the device, or the device may be configured to download the start and end locations from a remote location.

Further optional features of the second aspect of the invention are set out below.

Advantageously, the comparison processor is configured to compare more than one of the first journey segments.

Conveniently, the comparison processor is configured to compare each of all of the first journey segments.

Preferably, the second route processor is configured to determine a predicted time for the second route.

Advantageously, the second route excludes at least one segment of the first route.

Conveniently, the device is configured to replace the first route with second route if the predicted time for the second route is shorter than the predicted time of the first route.

The device may include display means, for example a screen. The display means may be used to display a route to a user of the device. The route may be the first route or the second route. The user may be able to compare the first and second routes on the display means.

For example, the user may be presented with the second, optimised route. The user of the device may be directed by the device to follow the second route. In this way they user is directed along an optimised route that will be shorter than the un-optimised first route that they would otherwise have been directed to follow.

The present invention uses conditions observed across multiple journeys and time periods to provide a route that avoids known traffic congestion or choke points. In other words the system learns from completed journeys completed and can reroute future journeys to take into account those conditions.

Preferably, the segmentation processor is configured to segment the second route into a plurality of second route segments.

This segmentation may include determining the boundaries between segments. By segment of a route it is meant a portion or subsection of a longer overall route. The segmentation may comprise a division of the route, the dividing points occurring at a plurality of boundaries.

Advantageously, the comparison processor is configured to compare at least one of the second route segments to the historical data.

Conveniently, the predicted time for the second route uses data from the primary database.

Preferably, the second route processor is configured to predict metrics for the first journey segments.

Equally, any other processor may be used to the predict the metrics for the first journey segments.

Advantageously, the historical data includes a plurality of historical journeys, wherein each historical journey is between a historical start location and the historical end location.

Conveniently, each of the historical journeys includes at least one historical segment.

Preferably, each of the historical segments includes historical metrics.

Advantageously, the comparison processor is configured to identify relevant historical segments that correspond to segments of the first journey.

Conveniently, the comparison processor is configured to compare predicted metrics for the first journey segments to the historical metrics of the relevant historical segments.

Preferably, the comparison processor is configured to identify a first journey segment as a choke segment from the historical data.

Advantageously, the at least one choke segment is identified by historical metrics.

Conveniently, the historical metrics and predicted metrics include at least one of average speed, minimum speed, maximum speed, time taken in sector, and distance travelled in a segment.

Preferably, the second route avoids at least one of the at least one identified choke segments.

Advantageously, the segmenting processor is configured to analyse the speed of a vehicle travelling along a similar historical journey.

Conveniently, changes in the speed of the vehicle are identified.

Preferably, the boundaries of the segments are associated with significant changes in speed.

Advantageously, at least one of the segments corresponds to at least one of a section of a road, a road junction, a roundabout, or a set of traffic lights.

Conveniently, the historical data includes segment data, the segment data including at least one of: geographical boundaries for the sector, average speed, minimum speed, maximum speed, distance travelled in sector, and time taken in a sector of a historical journey.

For each historical journey, the historical data may include GPS data for the journey. The GPS data may include latitude, longitude, velocity, time, heading etc. The GPS data may be a sequence of values measured at points along the journey. The measurements may have been made periodically. For example, the GPS data may include a sequence of velocity values corresponding to the journey. In the velocity example therefore, the velocity can be determined along the journey. The database may also include a delivery ID foreign key, and/or a GPS entry ID primary key.

Preferably, the historical data includes the start and end times of a historical journey.

Advantageously, the comparison processor is configured to compare a first journey segment to historical data for journeys that occurred during a defined time of day.

Conveniently, the defined time of day is the times of day of the first journey.

Preferably, the historical data includes the vehicle type that undertook each historical journey.

Advantageously, the comparison processor is configured to compare the first route only to historical data for which the vehicle is of a similar type to the user's vehicle.

Conveniently, the vehicle type is at least one of a moped, a lorry, a car, a motorbike, or a bicycle.

Preferably, the first and second routes are different.

Advantageously, further including means for obtaining at least one stop along the first route.

The means for obtaining the at least one stop may the same as the means for obtaining the start and end locations. The at least one stop may be obtained at the device at the same time as the start and end locations. A stop may include details of the location of the stop, for example a street address, a post code, and or a latitude/longitude.

Conveniently, the first route and the second route are determined to pass through the at least one stop.

The second route may pass through the stops in the same order as in the first route. Alternatively, the order of the stops may be different to the order of the stops in the first route.

Preferably, the at least one stop is a plurality of stops.

The device may be able to cope with a number of stops along a route. The stops may correspond to the locations of a number of deliveries to be made by a user.

Advantageously, a final stop is not the end location.

In other words, the device can optimise a route from the start location, via at least one stop, to an end location. The end location need not be a “stop” along the route.

Conveniently, the plurality of historical journeys includes a close journey, wherein the historical end location of the close journey is within a predefined distance of the end location.

Preferably, at least one of the segments of the second route are equal to at least one of the segments of the close journey.

Advantageously, further including second obtaining means for acquiring details of a second journey.

The second obtaining means may be the first obtaining means. In other words, any stops may be input into the device in the same way as the start and end locations.

Conveniently, a final segment comprises a concluding portion of the first route, and the device is configured to predict a predicted final distance to the destination.

Preferably, the device is configured to measure an actual final distance travelled in the final segment.

Advantageously, the device is configured to calculate the difference between the actual distance and the predicted final distance.

Conveniently, the device is configured to record the actual location of the destination as a place point if the difference between the actual final distance and the predicted final distance is greater than a configured distance.

Preferably, the place point includes a measurement of the device at the destination.

Advantageously, the configured distance is 0.25 miles.

Conveniently, the configured distance is a final fraction of the predicted final distance.

Preferably, the final fraction is 10%.

Advantageously, the database is a relational database.

Conveniently, the device is configured to record a deviation from a route made by the user.

Preferably, the device is configured to determine if the deviation resulted in a shorter or longer total journey time.

Advantageously, the device is configured to record actual journey data taken during at least ne journey on a secondary database.

The device may have a GPS capability to measure its position. The device may be a satellite navigation device. The device may be a mobile telephone that has a GPS capability.

Conveniently, the secondary database is stored on the device.

Preferably, the device is configured to upload the data from the secondary database to a remote primary database.

It will be appreciated that the historical database will be populated by data corresponding to historical journeys. The data for these journeys may be recorded by conventional satellite navigation devices, or may be recorded by the devices of the present invention. By way of example, a device/devices according to the present invention may be used on journeys over a period of time. The data corresponding to these journeys can be used to populate historical journey database.

As the number of journeys in the historical journey database increases, the more effectively the present invention will be able to optimise a journey.

Advantageously, the remote primary database is the historical journey database.

Conveniently, the device further includes uploading the actual journey data from the at least one journey to the primary database.

Preferably, the primary database is located on a remote server.

The remote server may be accessed via remote communication means, for example the mobile telephone network. Alternatively, it may be that the communication between device and server is via fixed communication means, for example, the device may be plugged into a computer. The computer may then include the server. Or the computer may connect remotely to the server, for example via the internet.

It will be appreciated that the features of the first aspect of the invention may be implemented in the device of the second aspect. Equally, it will be appreciated that the features of the second aspect of the invention may be implemented in the method of the first aspect of the invention.

According to a third aspect of the present invention, an apparatus for improving navigation device accuracy is provided. The apparatus includes a navigation device; a primary storage means comprising a primary database, the primary database containing historical data for a plurality of historical journeys. The device is configured to obtain destination information defining a desired destination; and wherein the device is further configured to query the primary database to identify a historical visit to the destination. The historical visit includes measured location information for the destination.

In this way, the device does not rely on directions to the desired destination that only make use of maps. Instead, the navigation device according to the present invention allows a user to navigate directly to a previously measured position for their destination. This measured position having been measured during a historical journey to the same location. The present invention is particularly useful where repeated journeys are made to the same location, but not by the same user.

Over a period of time an increasing number of addresses will have precise coordinates (measured location) thereby reducing fuel consumption by precisely locating the delivery address.

For example, when delivering food the turnover of delivery drivers can be high. As such, while a given driver may know where a destination is located through their experience of travelling there, that information is lost when that driver leaves the delivery business. By the using the present invention, a driver can directed to the precise location of their destination.

Further optional features of the third aspect of the invention are set out below.

Preferably, the device is configured to direct a user to a location associated with the measured location information.

In the way the user is direct a user to the measured physical location of the destination, rather than where a conventional satellite navigation system may believe it to be using conventional maps.

Advantageously, the location is a measured location of an address.

Conveniently, the location was previously measured by a second navigation device during a historical visit to the destination.

The location may have been measured when destination was reached on the historical journey. A user may trigger the performance of the measurement of the location.

Preferably, the historical data further includes journey information for each historical journey stored in the primary database.

For each historical journey, the historical data may include GPS data for the journey. The GPS data may include latitude, longitude, velocity, time, heading etc. The GPS data may be a sequence of values measured at points along the journey. The measurements may have been made periodically. For example, the GPS data may include a sequence of velocity values corresponding to the journey. In the velocity example therefore, the velocity can be determined along the journey. The primary database may also include a delivery ID foreign key, and/or a GPS entry ID primary key for use in a relational database. The delivery ID may be used to prioritise end locations where the end locations visited more frequently are optimised more accurately.

Advantageously, the journey information includes a note, wherein the note includes information about the destination.

For example, the note may include information about locations of the letterboxes, doorbells etc. or any other information that it may be useful for a subsequent visitor to the location to know. A user may input the information for the note into the device when they reach the destination.

Conveniently, a secondary storage means is located local to the device.

The secondary database may be stored on the secondary storage means.

Preferably, the primary storage means is remote from the device.

Advantageously, the primary storage means is located on a server.

The historical data is stored on the primary database. The primary database may be located on the device itself, or may be remote from the device, for example on a remote server.

Further to the primary database, a secondary database may be stored on the device. The secondary database may be used to store a portion of the primary database that has been downloaded from the primary database according to the needs of the user. The secondary database may also or alternatively be used to store data produced by the device about the journeys the device undertakes and records. This recorded data may then be uploaded to the primary database.

The remote server may be accessible via a wireless network, for example the mobile telephone network or over an internet connection.

Conveniently, the device includes wireless communication means for wireless communication with the server.

The device may be an electronic navigation device. The device may be a dedicated satellite navigation device. Alternatively, the navigation device may be a mobile phone or tablet computer. The important factor is that the navigation device has the capability to determine its location. This position determination may be via a global satellite navigation system (GNSS), for example the Global Positioning System (GPS), the GLONASS system, or the GALILEO system.

The device may be suitable for use in vehicle, or mounted to a bicycle, or for use while a user is walking. The device may be capable of displaying directions to a user on a screen. The device may also be able to provide audio instructions to a user as they travel along a journey.

These instructions may be instructing the user the route to take as they progress along their journey in order that they arrive at their desired destination.

Preferably, the device is configured to download at least a portion of the primary database from the server.

The device may download via the mobile phone network or via the internet, for example. The device may query the primary database. The query may include details of a desired destination. The server may respond with measured location information from at least one historical visit to the desired destination.

Advantageously, the device is one of a mobile phone, or a satellite navigation device or any device with wifi capability and GPS location capability.

Conveniently, the destination information includes a street address.

Preferably, the destination information includes a building name.

Advantageously, the location information defines the location.

Conveniently, the location information includes the measured latitude and longitude of the destination.

Preferably, the device is configured to record journey information.

Advantageously, the device is configured to upload recorded journey information to the primary database.

Conveniently, the device is configured to measure the exact location of a destination.

It will be appreciated that the primary database will be populated by data corresponding to historical journeys. The data for these journeys may be recorded by conventional satellite navigation devices, or may be recorded by the devices of the present invention. By way of example, a device/devices according to the present invention may be used on journeys over a period of time. The data corresponding to these journeys can be used to populate a primary database that will form a historical journey database. Each of these journeys may include at least one measured location. The data for each journey may include a plurality of measured locations.

A particular address stored in the historical database may have a measured location associated with it. If a user requests to go to go that destination again, the database may instruct the user to go to the measured location.

For each historical journey, the historical data may include GPS data for the journey. The GPS data may include latitude, longitude, velocity, time, heading etc. The GPS data may be a sequence of values measured at points along the journey. The measurements may have been made periodically. For example, the GPS data may include a sequence of velocity values corresponding to the journey. In the velocity example therefore, the velocity can be determined along the journey. The database may also include a delivery ID foreign key, and/or a GPS entry ID primary key.

According to a fourth aspect of the invention, a method of improving navigation device accuracy is provided. The method including obtaining destination information defining a desired destination; querying a primary database to identify a historical visit to the destination, the primary database containing historical data for a plurality of historical journeys; wherein the historical visit includes measured location information for the destination.

Further optional features of the fourth aspect of the invention are set out below.

Preferably, the method further comprises directing a user to a location associated with the measured location information.

Advantageously, the location is a measured location of an address.

Conveniently, the location was previously measured by a navigation device during a historical visit to the destination.

Preferably, the historical data further includes journey information for each historical journey stored in the database.

Advantageously, the journey information includes a note, wherein the note includes information about the destination.

Conveniently, the primary database is queried remotely.

Preferably, the method further includes downloading at least a portion of the primary database.

Advantageously, the destination information includes a street address.

Conveniently, the destination information includes a building name.

Preferably, the location information defines the location.

Advantageously, the location information includes the measured latitude and longitude of the destination.

Conveniently, the method further includes recording journey information.

Preferably, the method further includes uploading recorded journey information to the primary database.

Advantageously, the method further includes measuring the exact location of a destination.

It will be appreciated that the features of the third aspect of the invention may be implemented in the device of the fourth aspect. Equally, it will be appreciated that the features of the fourth aspect of the invention may be implemented in the device of the third aspect of the invention.

### BRIEF DESCRIPTION OF THE DRAWINGS

Embodiments of the invention will now be described by way of example with reference to the accompanying drawings in which:

FIG. 1 shows an embodiment for implementing the method according to the first aspect of the invention; and device according to the second aspect of the present invention;

FIG. 2 shows a an example of the separation of a journey into segments according to the first and second aspects of the present invention;

FIG. 3 shows a graph indicating the segments of a journey according to the first and second aspects of the present invention;

FIGS. 4A and 4B illustrate an advantage of the first and second aspects of the present invention;

FIGS. 5A and 5B illustrate an advantage of the third and fourth aspects of the present invention, and;

FIGS. 6A and 6B illustrate an advantage of the third and fourth aspects of the present invention.

### DETAILED DESCRIPTION

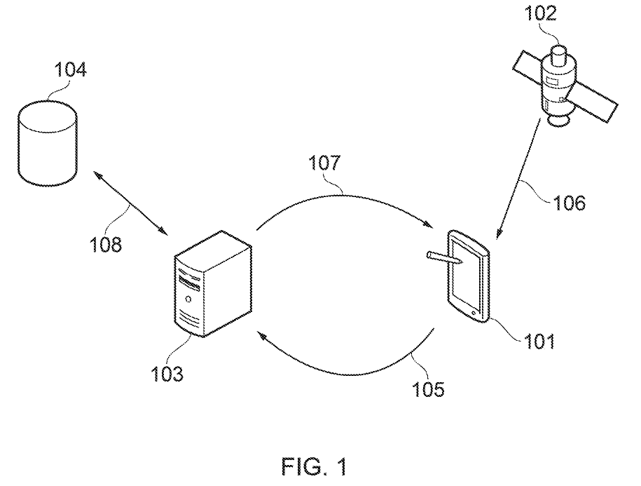

FIG. 1 shows a device 101. The device 101 is able to receive signals from the satellites 102 of a global positioning system. The device 101 is consequently able to determine its position on the earth. The device can do this essentially in real time, and so can determine tracking of its position through periodic measurements of its position.

The device may be a satellite navigation device (a “sat-nay”), a mobile phone with satellite navigation capability, or another suitably enabled device. The device 101 determines a first route between a start location and an end location using a standard route finding algorithm.

The first route may be determined by the device 101. The device 101 may run a software application that is able to determine the first route.

The server 103 determines a second route between the start and end locations which avoids choke points between the start and end locations. Choke points may be areas along the route where there has historically been heavy traffic, and consequent delays. If a user of the device 101 were to travel through these choke points, they would be delayed.

In the illustrated embodiment, the device 101 is provided 107 with a second route by the server 103. The second route avoids known congestion areas (choke points). The second route may be sent 107 to the device 101 via the mobile telephone network.

The second route is determined based on historical journey data stored in the database 104.

The device 101 is carried by a user as they undertake journeys. During these journeys the device 101 records tracking information (for example, position, speed, heading). This tracking information is stored on the device 101 for later retrieval. The tracking information is then sent 105 to the server 103. The database 104 is updated with the tracking information for use by a device in the future in determining optimised routes. The database is therefore updated 108 by the use of device(s) 101 that send their tracking information to the server 103 that updates 108 the database 104.

The primary database 103 is therefore gradually populated and maintained with historical journey information that can then be used by the same device 101, or other similar devices using the present invention. The device 101 may store on the device information regarding a number of journeys before uploading 105 the historical journey information to the server 103 and ultimately the primary database 104. For example, the device 101 may only upload journey information to the server once per day. The device may temporarily store information regarding a number of journeys on a secondary database located on the device.

The device 101 is a mobile device that uses a Global Positioning System (GPS) to track and record the entire delivery trip. The delivery trip information is then used for learning. At the end of the day (or when device as access to the server) the information is pushed up to a primary database 104 for analysis. Before a delivery is performed a journey route will be downloaded onto the mobile device 101 and the application.

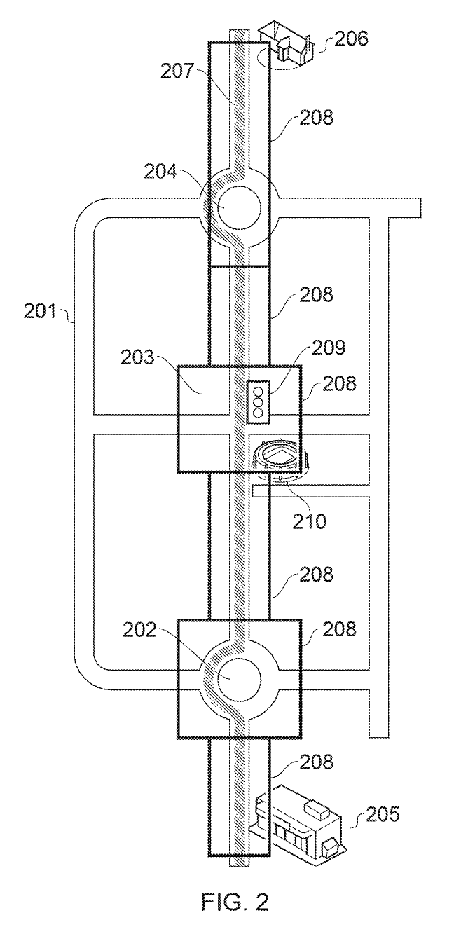

The learning process works by breaking down the journey route into segments at street level. Each segment is analysed by total time taken, distance travelled and waiting time (FIG. 2). Segments may include a number of keys, for example, delivery ID foreign key, GPS entry ID foreign key, sector ID primary key.

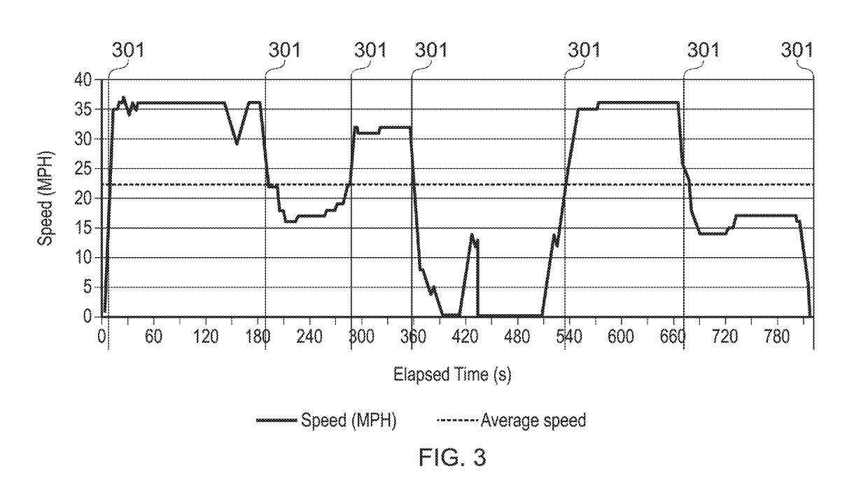

The primary database stores the boundaries described in FIG. 3 for each sector and calculated metrics for the sector (average speed, minimum speed, maximum speed, time taken in sector, distance travelled in sector), and if the sector is a choke point. The primary database will contain delivery information and GPS coordinate data for all previous deliveries taken. The primary database includes relational tables for:
The source & destination for deliveries that were made, including delivery address, postcode, order time, dispatch time (delivery ID primary key).
GPS data for the deliveries including latitude, longitude, velocity, time, heading etc (delivery ID foreign key, GPS entry ID primary key)
Sectors identified in the delivery data. (delivery ID foreign key, GPS entry ID foreign key, sector ID primary key). The primary database stores the boundaries described in FIG. 3 for each segment and calculated metrics for the segment (average speed, minimum speed, maximum speed, time taken in segment, distance travelled in segment), and if the sector is a choke point
Alternate routes for a given segment as supplied by existing route finding system for all segments identified as choke points (sector ID foreign key, alternate route primary key)

2 shows a road map upon which the principles of the problem addressed by the present invention are shown. The map shows a network of roads 201. The network of roads 201 includes a number of junctions 202, 203, 204. Some junctions contain road features like roundabouts 202, 204, or traffic lights 209 on one junction 203. A user wishes to travel between a start location store 205 and the end location house 206. An initial first route 207 directs a user from the store 205 across the junctions 202, 203, 304 to the house 206. The first route 207 has been determined using a standard route finding algorithm, and takes the most direct route from the store 205 to the house 206. The first route is the best approximation to a straight line between the store 205 and the house 206 using the available road network 201. A standard route finding algorithm predicts that the first route 207 is the quickest way to travel from the store 205 to the house 206.

The first route 207 has been segmented into segments 208. The segments of the route 207 are shown surrounded by boxes. The segments 208 cover the total length of the route 207 from the store 205 to the house 206. Each of the segments contains a road feature. One segment contains junction 202, another segment contains junction 204, and a third contains junction 204. Junction 204 includes a set of traffic lights 209, which periodically cause traffic flowing through junction 203 to come to a stop. A stadium 210 is shown adjacent to the junction 203. It will be appreciated that the stadium 210 is a potential source of heavy traffic, when people are travelling to or from a match for example. The stadium 210 is therefore responsible for heavy traffic which depends on whether there is a match being played at the stadium 210 that day. Furthermore, the heaviness of the traffic depends on the time of day on which the match is played, for example traffic will be heavier before and after the match. The heaviness of the traffic around junction 203 therefore varies with time.

A user who follows the first route 207 would either encounter heavy traffic around the junction 203 adjacent to the stadium before or after a match is played.

FIG. 3 shows a plot of measured speed along a journey. The speed is seen to vary as time elapses. Time elapsing corresponds to the journey progressing. Clearly, when the speed is zero, the device with which the measurements were made was stopped. When stopped the user who has the device is making no progress towards their destination, which increases the total time to reach their destination. This is undesirable.

The data shown in FIG. 3 is stored in a database. The speed data shown in FIG. 3 is analysed to identify sharp changes in speed (increases and/or decreases in speed). The sharp changes in speed 301 are indicated by the vertical lines on the figure. By identifying the sharp changes in speed, the times at which the sharp changes in speed occurred can be determined. For example, each of the speed measurements includes a time stamp. The time of a sharp change in speed can then be determined by interpolating between the time stamp of the speed measurements made before and after the identified sharp change in speed. Once the time of the sharp change in speed is identified, the position data, which is also available for the historical journey, can be used to identify the geographical location of each sharp change in speed. The journey is then segmented, where the geographical boundaries are located at the geographical locations of the sharp changes in speed.

The process is repeated for any previous journeys for journeys to the same address or similar postcodes, at the same or similar times of day. The slowest segments of these journeys are identified as choke points.

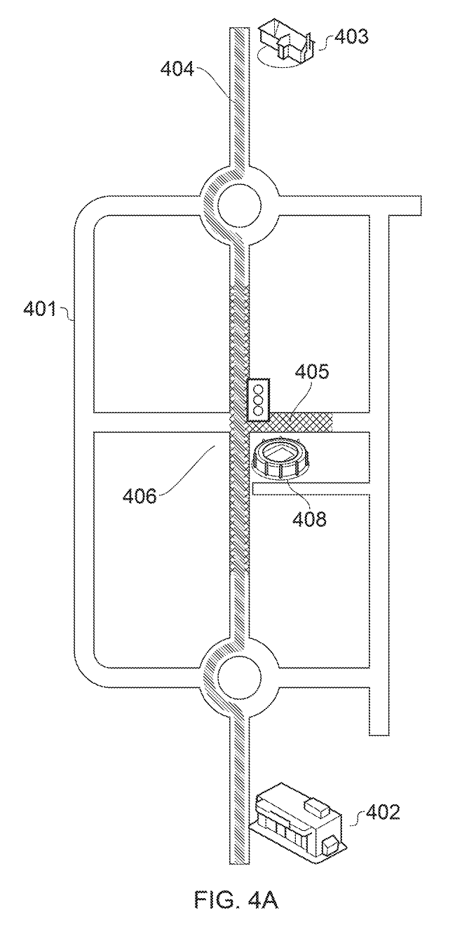

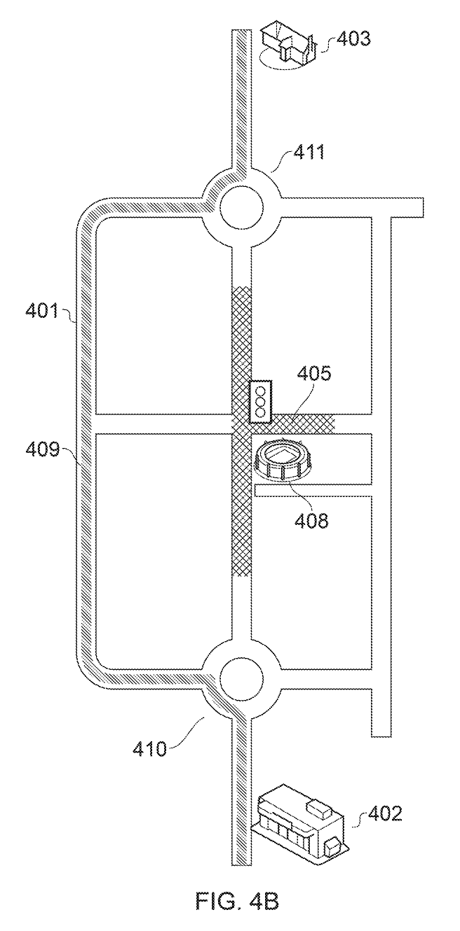

FIG. 4A shows a road map upon which the principles of the problem addressed by the present invention are shown. The map shows a network of roads 401. A user wishes to travel between the store 402 and the house 403. An ordinary route finding algorithm has been used to determine an initial first route 404 to direct a user from the store 402 to the house 403. The first route 404 consists of the most direct route from the store 402 to the house 403. The first route is the best approximation to a straight line between the store 402 and the house 403 using the available road network 401. The route 404 may equal the route that has been determined by the ordinary route finding algorithm, which may not necessarily be the route covering the shortest distance. A standard route finding algorithm predicts that the first route 404 is the quickest way to travel from the store 402 to the house 403.

A region of congestion 405 is located in the vicinity of the central junction 406. The junction 406 is adjacent to the stadium 408. The congestion or heavy traffic around junction 406 would mean that if a user were to follow the first route 404, then they would encounter the congestion 405, and would be delayed along the journey. It would take the user longer to reach the house 403 than is predicted for the first route 404.

FIG. 4B shows a road map upon which the principles of the present invention are shown. Where the elements are identical to those shown in FIG. 4A, the element has been assigned the same reference number.

FIG. 4B shows a network of roads 401. A user wishes to travel between the store 402 and the house 403. A first route from an ordinary route finding algorithm has been optimised according to the present invention to determine the second route 409 between the store 402 and the house 403. It will be noted the second route 409 and the first route 404 (shown in FIG. 4A) are not the same and do not cover the same roads.

The second route 409 avoids the region of congestion 405 that is located in the vicinity of the central junction. A user who travels along the second route 409 will not therefore be delayed by the congestion 405. A user who followed the second route 409 would take different turnings along the way to a user who followed the first route, for example at the lower junction 410 and the upper junction 411.

The congestion 405 was identified as a choke point in historical data for journeys made between the store 402 and the house 403. The second route 409 was determined to avoid the choke point identified in the historical data. Historical journeys that had taken place at similar times of day or week would often experience congestion 405 at the same location. As such, the congested region 405 was identified as a choke point. The congestion may have been caused by the beginning or end of match at the stadium 408.

It will be understood that the stadium example is used simply to demonstrate time-dependent heavy traffic/congestion. The present application is applicable to any situation in which there is time-variable traffic patterns.

The congestion or heavy traffic 405 would mean that if a user were to follow the first route 404, then they would encounter the congestion 405, and would be delayed along the journey. It would take the user longer to reach the house 403 than is predicted for the first route 404.

Having identified the choke points, the present invention will determine alternative routes that bypass the choke points. Such routes will vary to account for observed historic patterns at different times of the day. For example, the delivery starting time for each day will be divided into hourly slots for each day of the week. In our experience, a dataset spanning a four-week period provides sufficient accuracy for the optimised routes to provide real benefits.

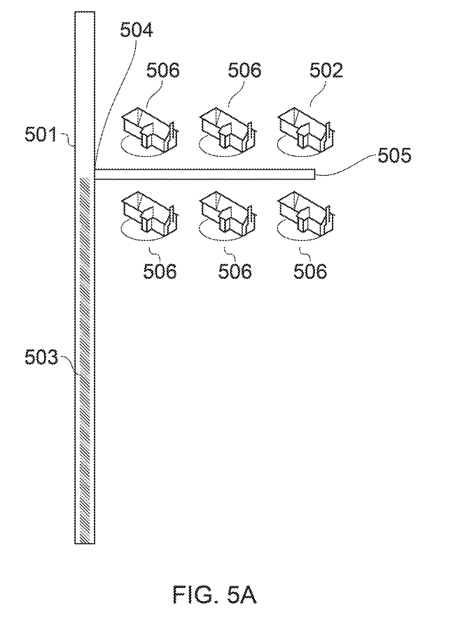

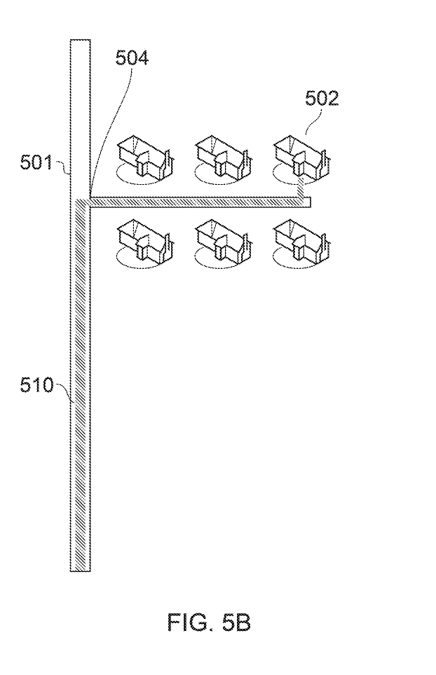

FIG. 5A shows a road map upon which the principles of the problem addressed by the present invention are shown. The map shows a network of roads 501. A user is trying to the reach their destination 502. A conventional navigation system has provided the user with a route to what the navigation system believes is the user's desired destination. The final portion of the route 503 that has been provided to the user is also shown. The final portion of the route concludes at the entrance 504 to the correct road 505 on which the desired destination 502 is located. The final portion 503 of the route does not lead the user to their desired destination.

The road 505 also includes number of other houses 506. The other houses 506 do not correspond to the desired destination 502. The other houses 506 may have the same postcode as the desired destination 502. In order to reach their destination, the user must navigate their way from the entrance of the road 504 to their final destination 502 without the assistance of the navigation system. For instance, they may have to drive slowly along the road 502 looking at the numbers of the houses until they identify their desired location 502. This is a time-consuming process.

If the distance between the entrance to the road 503 and the eventual location of the desired destination 502 is above a predetermined value, then that may be used as a cue to make a measurement of the location of the desired destination 502.

When the driver does arrive at their desired destination 502, the device makes a measurement of the location of the device, and hence of the desired destination 502. This measurement, and the corresponding desired location are then stored on a database. The data may be sent directly to the database, or may be temporarily stored on the device before later being sent to the database. For example, at the end of each day a device may upload the data from all of its journeys that day. In this way, a database of historical destination locations is populated, where there is a measured location for each destination.

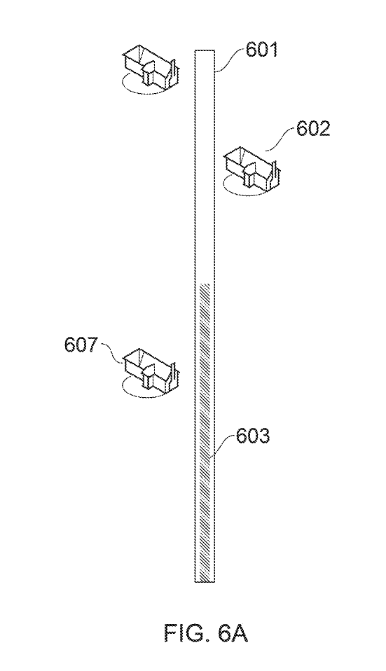

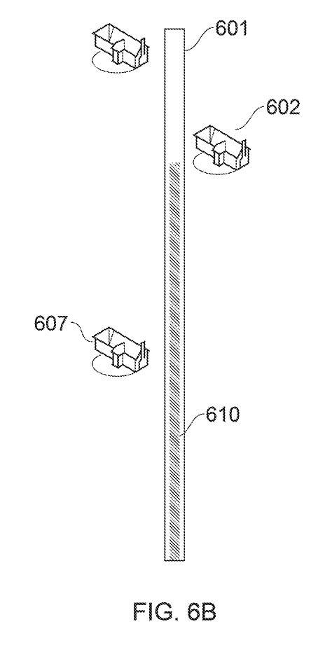

FIG. 5B shows the road 501 map of FIG. 5A. The final portion 510 of the improved route that is provided to a user in accordance with the present invention is also shown. Since a historical visit has been made to the same desired destination 502 (see FIG. 5A) the present invention provides an improved route to the exact measured location of the desired destination 502. The final portion 510 of the improved route supplied to the user in accordance with the present invention therefore leads the user directly to their destination, and no longer concludes at the entrance of the road 504. As such, the user reaches their desired destination 502 more quickly because a measurement of the exact location of the user's desired destination 502 was made during a historical visit to the desired destination. There is no need for the user to manually locate their desired destination, by reading house numbers, for example. FIG. 6A shows a road map upon which the principles of the problem addressed by the present invention are shown. The map shows a network of roads 601. A user is trying to the reach their destination 602. The user's desired destination 602 is a named house/building. As such, a conventional satellite navigation device is unable to interpolate a location for the house/building within a postcode area, for example. A second named house 607 is also shown on the map. A conventional navigation system has provided the user with a route to what the navigation system believes is the user's desired destination 602. The final portion of the route 603 that has been provided to the user is also shown. The final portion of the route 603 provided by a conventional satellite navigation system is unable to lead the user to their desired destination 602.

In order to reach their desired destination 602, the user must navigate their way from the concluding point of the route 603 to the desired destination without the assistance of the navigation system. For instance, a user may have to drive slowly along the road 601 looking at the names of the houses until they identify their desired location 602. This is a time-consuming process. This task is further complicated because a conventional satellite navigation device may incorrectly tell a user that they have reached their destination when they reach the conclusion of the route 603.

When the driver does arrive at their desired destination 602, the device makes a measurement of the location of the device, and hence of the desired destination 602. This measurement, and the corresponding desired location are then stored on a database. The data may be sent directly to the database, or may be temporarily stored on the device before later being sent to the database. For example, at the end of each day a device may upload the data from all of its journeys that day. In this way, a database of historical destination locations is populated, where there is a measured location for each destination.

FIG. 6B shows the road 601 map of FIG. 6A. The final portion 610 of the improved route that is provided to a user in accordance with the present invention is also shown. Since a historical visit has been made to the same desired destination 602 (see FIG. 6A) the present invention provides an improved route to the exact measured location of the desired destination 602. The final portion 610 of the improved route supplied to the user in accordance with the present invention therefore leads the user directly to their destination, and no longer concludes at the wrong location (between houses 602 and 607). As such, the user reaches their desired destination 602 more quickly because a measurement of the exact location of the user's desired destination 602 was made during a historical visit to the desired destination. There is no need for the user to manually locate their desired destination by reading house names, for example.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1-58. (canceled)

59. An apparatus for improving navigation device accuracy, comprising:
a first navigation device;
primary storage means comprising a primary database, the primary database containing historical data for a plurality of historical journeys;
wherein the device is configured to obtain from a user destination information defining a desired destination;
wherein the device is further configured to query the database to identify a historical visit to the destination;
wherein the historical visit includes measured location information for the destination, and the measured location information includes a measured location, the measured location having been measured by a second navigation device during a historical visit to the destination;
wherein the first navigation device is configured to direct the user to the measured location.

60. A device according to claim 59, wherein the location is a measured location of an address.

61. A device according to claim 59, wherein the historical data further includes journey information for each historical journey stored in the database.

62. A device according to claim 61, wherein the journey information includes a note, wherein the note includes information about the destination.

63. A device according to claim 59, wherein the primary storage means is local to the first navigation device.

64. A device according to claim 59, wherein the primary storage means is remote from the first navigation device.

65. A device according to claim 64, wherein the primary storage means is located on a server.

66. A device according to claim 65, wherein the device includes wireless communication means for wireless communication with the server.

67. A device according to claim 66, wherein the device is configured to download at least a portion of the primary database from the server to a secondary database located on the first navigation device.

68. A device according to claim 59, wherein the first navigation device is configured to record journey information.

69. A device according to claim 68, wherein the first navigation device is configured to upload recorded journey information to the database.

70. A device according to claim 59, wherein the first navigation device is configured to measure the exact location of a destination.

71. A method of improving navigation device accuracy on a first navigation device, comprising:
obtaining destination information defining a desired destination from a user;
querying a primary database to identify a historical visit to the destination, the primary database containing historical data for a plurality of historical journeys;
wherein the historical visit includes measured location information for the destination, the measured location information includes a measured location, the measured location having been measured by a second navigation device during a historical visit to the destination;
directing the user to the measured location.

72. A method according to claim 71, wherein the location is a measured location of an address.

73. A method according to claim 71, wherein the historical data further includes journey information for each historical journey stored in the primary database.

74. A method according to claim 71, wherein the journey information includes a note, wherein the note includes information about the destination.

75. A method according to claim 71, wherein the primary database is queried remotely.

76. A method according to claim 71, including downloading at least a portion of the primary database to a secondary database.

77. A method according to claim 71, including recording journey information to the secondary database.

78. A method according to claim 77, further including uploading recorded journey information to the primary database from the secondary database.

79. A method according to claim 71, including measuring the exact location of a destination.

80. A computer program comprising computer program code that when executed on one or a plurality of computing devices causes the computing device or devices to operate in accordance with the method of claim 71.

81. A method of journey optimisation, including the steps of:
obtaining start and end locations for a first journey;
determining a first route between the start and end locations;
segmenting the first route into a plurality of first journey segments;
comparing a first journey segment to historical data stored on a database, and;
determining a second route between the start and end locations based on the comparison of a first journey segment to the historical data, wherein the second route is predicted to take a shorter time than the first route.

82. A method according to claim 81, wherein the second route is segmented into a plurality of second route segments.

83. A method according to claim 81, wherein at least one of the second route segments is compared to the database.

84. A method according to claim 81, wherein the historical data includes a plurality of historical journeys, wherein each historical journey is between a historical start location and the historical end location.

85. A method according to claim 81, further comprising comparing predicted metrics for the first journey segments to historical metrics of the relevant historical segments.

86. A method according to claim 81, further comprising identifying a first journey segment as a choke segment from the historical data.

87. A method according to claim 86, wherein the second route avoids at least one of the at least one identified choke segments.

88. A method according to claim 81, wherein a first journey segment is compared to historical data for journeys that occurred during a defined time of day.

89. A method according to claim 81, wherein the historical data includes the vehicle type that undertook each historical journey.

90. A method according to claim 81, wherein the first and second routes are different.

91. A method according to claim 81, wherein the obtaining step further comprises obtaining at least one stop along the first route.

92. A method according to claim 91, wherein the first route and the second route are determined to pass through the at least one stop.

93. A method according to claim 81, wherein the plurality of historical journeys includes a close journey, wherein the historical end location of the close journey is within a predefined distance of the end location.

94. A method according to claim 93, wherein at least one of the segments of the second route are equal to at least one of the segments of the close journey.

95. A method according to claim 81, further including the step of acquiring details of a second journey.

96. A method according to claim 81, wherein a final segment comprises a concluding portion of the first route, the concluding portion having a predicted final distance to the destination.

97. A method according to claim 96, wherein the actual location of the destination is recorded as a place point if the difference between the actual final distance and the predicted final distance is greater than a configured distance.

98. A computer program comprising computer program code that when executed on one or a plurality of computing devices causes the computing device or devices to operate in accordance with the method of claim 81.

99. A device configured to optimise a journey, the device including:
means for obtaining start and end locations for a first journey;
a first route processor configured to determine a first route between the start and end locations;
a segmentation processor configured to segment the first route into a plurality of first journey segments;
a comparison processor configured to compare a first journey segment to historical data stored on a primary database, and;
a second route processor configured to determine a second route between the start and end locations based on the comparison of a first journey segment to the historical data, wherein the second route is predicted to take a shorter time than the first route.

100. A device according to claim 99, wherein the segmentation processor is configured to segment the second route into a plurality of second route segments.

101. A device according to claim 100, wherein the comparison processor is configured to compare at least one of the second route segments to the historical data.

102. A device according to claim 99, wherein the comparison processor is configured to compare predicted metrics for the first journey segments to historical metrics of the relevant historical segments.

103. A device according to claim 99, wherein the comparison processor is configured to identify a first journey segment as a choke segment from the historical data.

104. A device according to claim 103, wherein the second route avoids at least one of the at least one identified choke segments.

105. A device according to claim 99, wherein the comparison processor is configured to compare a first journey segment to historical data for journeys that occurred during a defined time of day.

106. A device according to claim 99, further including means for obtaining at least one stop along the first route.

107. A device according to claim 99, wherein the first route and the second route are determined to pass through the at least one stop.

108. A device according to claim 99, wherein the plurality of historical journeys includes a close journey, wherein the historical end location of the close journey is within a predefined distance of the end location.

109. A device according to claim 108, wherein at least one of the segments of the second route are equal to at least one of the segments of the close journey.

110. A device according to claim 99, further including second obtaining means for acquiring details of a second journey.

111. A device according to claim 99, wherein a final segment comprises a concluding portion of the first route, and the device is configured to predict a predicted final distance to the destination.

112. A device according to claim 99, wherein the device is configured to record the actual location of the destination as a place point if the difference between the actual final distance and the predicted final distance is greater than a configured distance.
